(19) United States
(12) Patent Application Publication
(10) Pub. No.: US 2007/0292199 A1
(43) Pub. Date: Dec. 20, 2007

(54) Lens pen

(76) Inventors: Richard Waldinger, Palm Beach Gardens, FL (US); Thomas A. McQueen, Delavan, WI (US)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 11/453,376

(22) Filed: Jun. 15, 2006

(51) Int. Cl. B43K 5/12; B43K 29/00

(52) U.S. Cl. 401/192; 401/195

(57) ABSTRACT

A writing instrument that provides a magnification lens to view a logo or visual image from inside the barrel of the pen. The writing instrument has a cartridge, printable sleeve, magnification member and a pen barrel. The pen barrel is capable of accepting the printable sleeve and cartridge therethrough. The pen barrel has a first end and a second end. On the surface of the pen barrel between the first and second ends there is a magnification member. The magnification member is capable of magnifying the visual image on the printable sleeve. The printable sleeve is movable between successive positions to successively display one or more visual images with respect to the magnification member. The magnification member can be a clear or tinted lens for magnifying visual images such as a logo or message.

### FIELD OF THE INVENTION

The invention relates to a writing instrument having a display window along the barrel with a clear or tinted magnifying lens which enlarges a logo or message provided inside the barrel or body member of the writing instrument, such as on the cartridge or message barrel. The lens is constructed from a synthetic material and is shaped to create magnification of the logo or message viewed. Usually writing instruments are relatively small and thus the surface area to include a message or logo would also be small. Therefore, this invention advantageously facilitates easy viewing of a message or logo inside the writing instrument. The writing instrument provides means for rotating the cartridge or surface on which message is contained, past the magnifying lens, to allow a series of material to be seen.

### BACKGROUND OF THE INVENTION

Writing devices are commonly used to display images or messages. Many of the writing instruments contain an opaque barrel having a covered window for displaying the logo or message. As some holes are open, some contain a transparent material covering the opening. Both constructions allow the user to see the message or logo. However, because writing instruments are relatively small, a small surface area is provided to contain a logo or message. Therefore, the ability to view and comprehend the information provided on a writing instrument is limited by the size of the writing instrument. Although the user can see the message or logo, it is usually very small and hard to see. Therefore, there is a need for a writing instrument that enhances a user's ability to see logos or advertisements inside a writing instrument.

### SUMMARY OF THE INVENTION

The present invention is a writing instrument that incorporates a clear or tinted lens for magnifying a logo or message contained in the body of the writing instrument, and is easy to operate.

In the preferred embodiment of the present invention the writing instrument comprises a pen barrel, advancing member, lens, a printable sleeve and a cartridge. The cartridge is generally tubular and has a first end and a second end. The first end of the cartridge has a means of writing. The printable sleeve is generally tubular. The printable sleeve has a first end and a second end. The cartridge is essentially co-axially aligned inside the printable sleeve. The printable sleeve contains a tubular surface area where multiple messages, logos or advertisements can be displayed.

The pen barrel contains a first end and a second end. The pen barrel has a hollow space that is defined by its shape. The first end of the pen barrel accepts the first end of the cartridge and printable sleeve. The cartridge and printable sleeve axially align inside the pen barrel. A window or opening in the surface of the pen barrel allows a user to view a portion of the printable sleeve or cartridge. Covering the window or opening is a lens. The lens provides magnification and may be clear or tinted and preferable constructed of a synthetic material. The lens can be flat and placed in the window in the pen barrel or molded in a 360-degree fashion to become apart of the pen barrel.

The writing instrument further comprises multiple advancing members. These advancing members work cooperatively to rotate the printable sleeve a predetermined degree and cause the cartridge to be in a writing or retracted position.

In another embodiment of the present invention the writing instrument comprises a printable cartridge, an advancing member and a pen barrel. The printable cartridge is generally tubular. The printable cartridge has a first end and a second end. The first end of the printable cartridge has a means of writing. In one embodiment of the present invention the means for writing is a ball point pen. The printable cartridge contains a tubular surface area where messages, logos or advertisements can be displayed. In one embodiment of the present invention the surface area is triangular. The second end of the printable cartridge contains a first advancing mechanism. The advancing member has a first end and a second end. The first end of the advancing member axially accepts the second end of the printable cartridge. The second end of the advancing member may be a button. The button contains a second advancing mechanism. When the button is pressed the first advancing mechanism and second advancing mechanisms cooperatively rotate the printable cartridge a predetermined degree. When the first and second advancing mechanisms cooperatively work to rotate the printable cartridge it causes the printable cartridge to rotate ninety degrees such that the printable cartridge can have four words, messages or logos for viewing upon each rotation.

### BRIEF DESCRIPTION OF THE DRAWINGS

A preferred embodiment of the present invention has been chosen for purposes of illustration and description and is shown in the accompanying drawings forming a part of the specification wherein:

FIG. 1 is a side cross-sectional view of the writing instrument wherein a first visual image is shown through the magnification display window and the writing element is in the writing position.

FIG. 2 is a cross sectional view taken along line 2-2 of the writing instrument of FIG. 1.

FIG. 3 is a top view of the writing instrument of FIG. 1.

FIG. 4 is an exploded view of another embodiment of the present invention.

FIG. 5 is an exploded view of the preferred embodiment of the present invention.

### DETAILED DESCRIPTION OF THE PREFERRED EMBODIMENTS

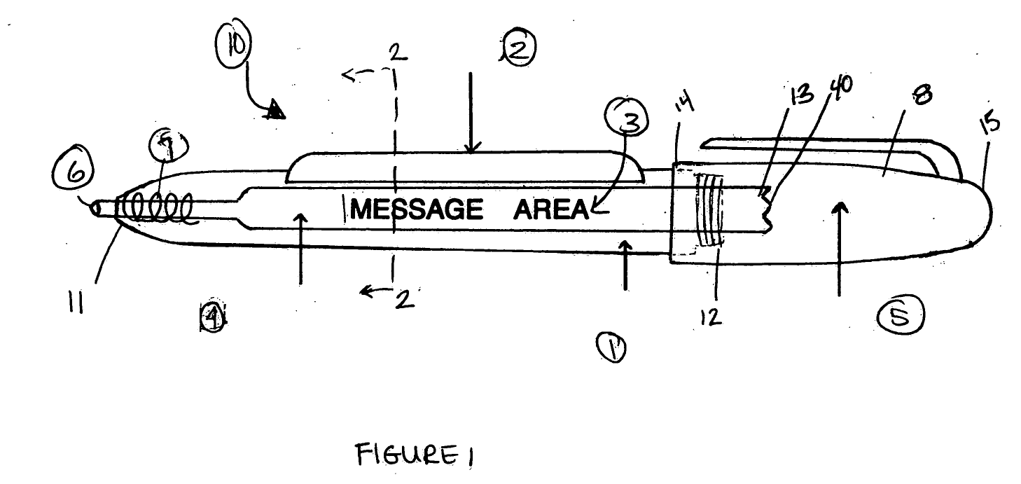

With reference to the drawings, wherein the same reference number indicates the same element throughout, there is shown in FIG. 1 a cross-sectional side view of a lens pen 10 of the present invention. As shown in FIG. 1, the lens pen 10 includes a pen barrel 1, a lens 2, a printable cartridge 4, a spring 7, a first advancing mechanism 40, a second advancing mechanism 5, and an advancing member 8. The printable cartridge 4 contains a message area 3, a writing end 6 and an advancing end 13.

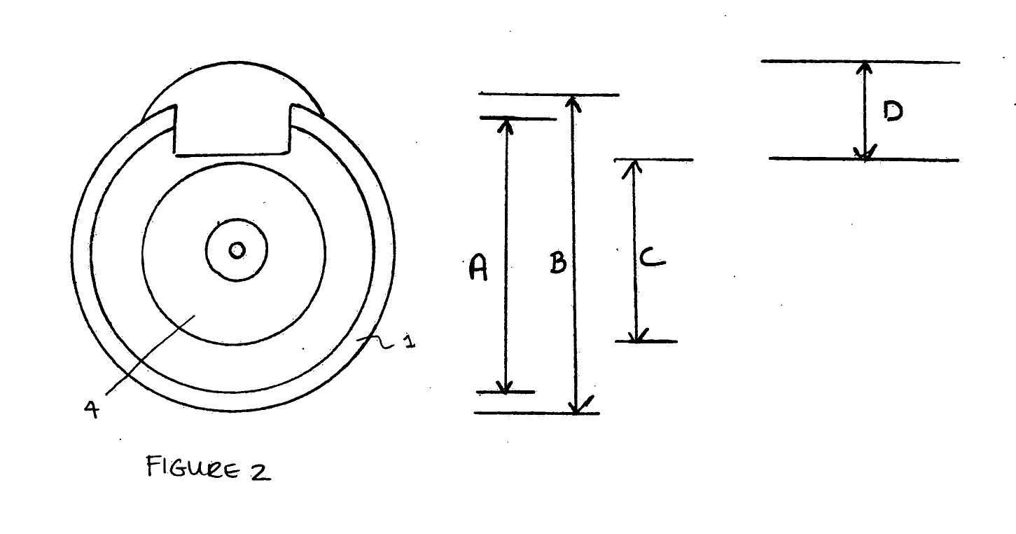

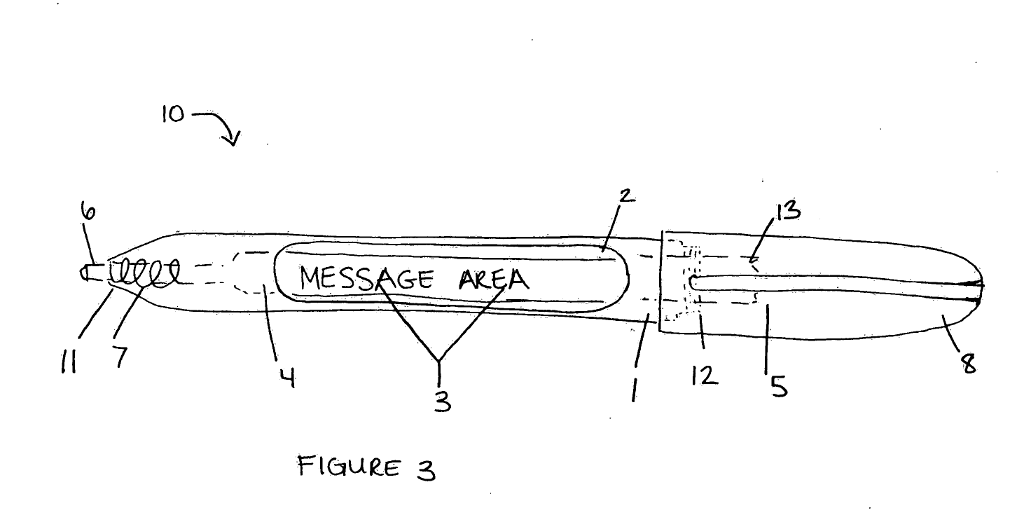

As shown in FIGS. 1-3, the lens pen 10 of the present invention has a pen barrel 1 containing a lens 2 which magnifies a message on the message area 3 on an internal printable cartridge 4 and allows it to be viewed therethrough. The pen barrel 1 may be constructed from various types of material including plastic. The pen barrel 1 has a circular cross section, but can have a non-circular cross section. The pen barrel may have a square, triangle, hexagon or octagon shape cross section. As shown in FIG. 2, the pen barrel 1 has an outside diameter B and an inside diameter A, defining the depth of the pen barrel 1. The pen barrel 1 has a first end 11 and a second end 12. In between the first end 11 and the second end 12 of the pen barrel 1 is a window that is capable of accepting the lens 2. The lens 2 can contain a flange. The flange allows the lens 2 to snap into the window of the pen barrel 1. The flange may have a rectangular or square cross section. The flange may be molded in a three hundred and sixty degree (360°) fashion to fit within the pen barrel 1. The spring 7 is concentrically nested inside the first end 11 of the pen barrel 1. The first end of the pen barrel 11 has an aperture that accepts the writing end 6 of the printable cartridge 4 therethrough. The second end of the pen barrel 12 has an aperture, capable of allowing the printable cartridge 4 therethrough. The writing end 6 of the printable cartridge 4 is axially placed into the second end of the pen barrel 12. The printable cartridge 4 is placed axially inside the pen barrel 1 until the writing end of the printable cartridge 6 axially engages the spring 7. The writing end 6 of the printable cartridge 4 extends through the spring 7 and the aperture of the first end of the pen barrel 1. The second end 13 of the printable cartridge contains a first advancing mechanism 40. The advancing member 8 has a first end 14 and a second end 15. The first end 14 of the advancing member 8 axially accepts the second end 13 of the printable cartridge. The second end 15 of the advancing member 8 may be a button or a cap. The second end 15 of the advancing member 8 contains a second advancing mechanism 5. When the button or cap is pressed the first advancing mechanism and second advancing mechanism 5 cooperatively rotate the printable cartridge 4 a predetermined degree. In one embodiment of the present invention the second end 13 of the printable cartridge 4 contains longitudinal ribs to correspond to longitudinal depressions in the advancing member 8.

The second advancing mechanism 5 rotates the printable cartridge 4 forty-five (45) degrees with each predetermined rotation and activation of the advancing member 8. The second advancing mechanism 5 can rotate the printable cartridge 4 sixty (60) degrees with each predetermined rotation and activation of the advancing member 8. As shown in FIG. 2, the printable cartridge 4 has a circular cross section C. The printable cartridge 4 can have a triangular, square or other shaped cross section (not shown).

The printable cartridge 4 has a message area 3 between the writing end 6 and the advancing end 13. A message or logo can be written directly on the printable cartridge 4. The printable cartridge 4 may contain four (4) or more messages or logos. The message area 3 can be externally viewed through the lens 2.

The lens 2 is shown to be clear. The lens 2 may also be tinted. The lens 2 can be constructed of a synthetic material. The lens 2 may be shaped in a manner known to one skilled in the art to create magnification. When viewed externally, the lens 2 magnifies the message of the printable cartridge 4. The lens 2 can be added to an existing pen barrels by providing an opening on the pen barrel 1. The lens can be molded in a three hundred sixty degree (360°) fashion to become part of the pen barrel 1 such that an individual lens is unnecessary.

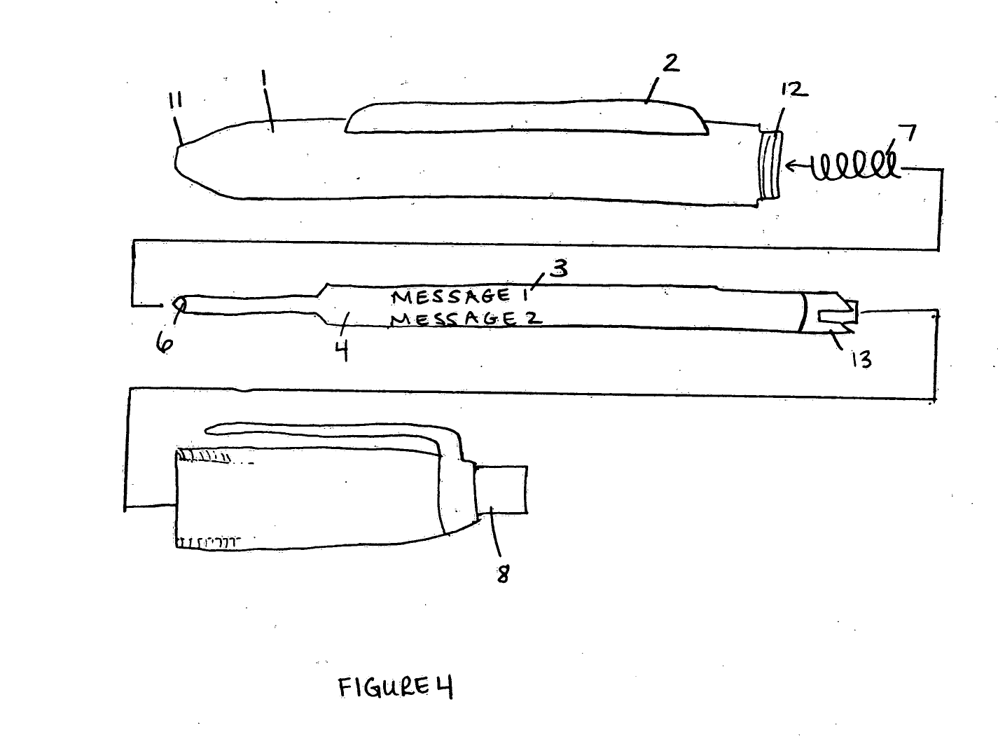

FIG. 4 is an exploded view of another embodiment of the present invention. The writing instrument shown comprises a pen barrel 1, a lens 2, a spring 7, a printable cartridge 4 and advancing member 8. The writing instrument of FIG. 4 is similar to the writing instrument of FIGS. 1-3 except that it has a button as an advancing member 8.

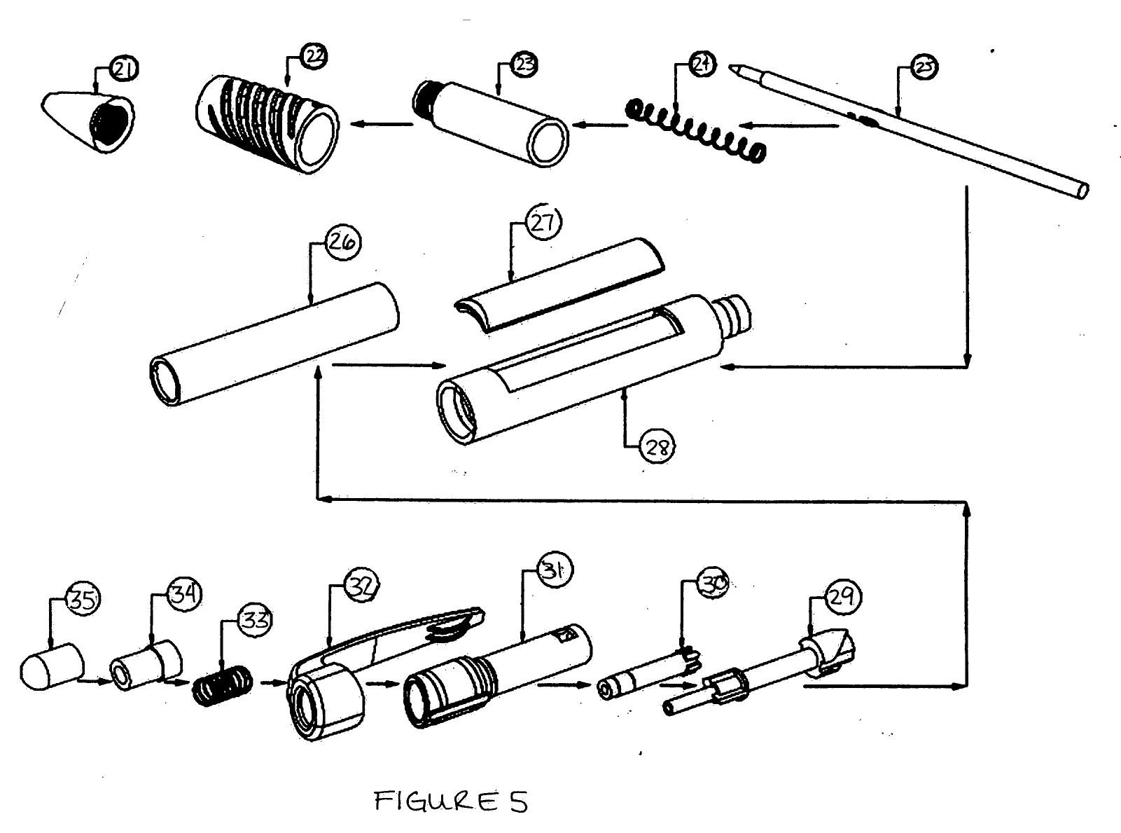

In another embodiment of the present invention the writing instrument comprises a printable sleeve similar to 26 of FIG. 5. The printable sleeve is capable of axially accepting the printable cartridge 4. The printable sleeve has a first end and a second end. A message area is in between the first and second end. A message or logo can be written on the printable sleeve. The message area can be externally viewed through the lens.

FIG. 5 is an exploded view of the preferred embodiment of the present invention. The writing instrument shown in FIG. 5 has a writing tip 21, finger pad 22, base member 23, first spring 24, cartridge 25, printable sleeve 26, lens 27, pen barrel 28, first advancing member 29, second advancing member 30, third advancing member 31, clip 32, second spring 33, pen top 34 and cap 35. The writing tip 21 has a first end, a second end and a hole therethrough to accept the cartridge 25. The second end of the writing tip 21 is internally threaded. The base member 23 has a first end and a second end. The first end is externally threaded to cooperatively engage the second end of the writing tip 21. The base member 23 is concentrically nested inside the finger pad 22. The cartridge has a first end and a second end. The first end of the cartridge has a writing means and concentrically nests within the first spring 24 and the base member 23. The pen barrel 28 has a first end and second end. The pen barrel 28 has a window between the first end and second end. The lens 27 has a flange that is capable of snapping into the window of the pen barrel 28. The first end of the pen barrel 28 is sized to receive and engage the second end of the base member 23. The second end of the pen barrel 28 axially accepts the printable sleeve 26 which encircles the cartridge 25. The printable sleeve 26 contains a message area 3. A message or logo can be written directly on the printable sleeve 26. The printable sleeve 26 has a first end and a second end. The second end of the printable sleeve 26 has an internal protrusion. The first end of the first advancing member 29 abuts the non-writing end of the cartridge 25 and has grooves that correspond to the internal protrusion of the printable sleeve 26. The second end of the first advancing member 29 has teeth. The first end of the second advancing member 30 has teeth that correspond to the teeth of the second end of the first advancing member 29. The third advancing member 31 has a first end and a second end. The first end of the third advancing member 31 has a larger radius than the second end. The second end of the third advancing member 31 has internal protrusions to correspond to the teeth of the first end of the second advancing member 30. The internal protrusions accept the teeth of the second end of the first advancing member 29. The first end of the third advancing member 31 axially engages the clip 32. The second spring 33 is sized so as fit axially within the first end of the third advancing member. The pen top 34 has a first end and a second end. The second end fits axially within the second end of the third advancing member 31. The cap 35 fits axially over the first end of the pen top 34. When pressure is applied to the cap 35 it causes the second spring 33 to be pressed down. This activates the second advancing member 30 which turns the first advancing member 29. When the first advancing member 29 is turned it rotates the printable sleeve 26 a predetermined degree and causes the cartridge to be activated.

1. A writing instrument providing a display of a message, comprising:
an outside body member having a first end and a second end;
a cartridge having a surface, containing ink for writing, said cartridge positioned axially inside said body member, and having a first end and a second end with said first end being a writing end, said first and second ends of said body member corresponding to said first and second ends of said cartridge; said cartridge being urged toward said second end of said outside body;
a magnification means positioned between said first end and said second end of said outside body member to magnify a message internally of said outside body member; and
wherein said surface of said cartridge having one or more visual images marked directly thereon; and wherein one of said visual image on said cartridge is aligned with said magnification means so that said one visual image is capable of being shown enlarged through said magnification means.

2. (canceled)

3. The writing instrument of claim 2, wherein said cartridge is rotatable between successive positions to display said one or more visual images with respect to said magnification means.

4. The writing instrument of claim 1 wherein said magnification means is a magnification lens.

5. The writing instrument of claim 1 wherein said magnification means is transparent.

6. The writing instrument of claim 3 wherein said magnification means is tinted.

7. A writing instrument having a display portion, comprising:
an outside body member having a first end and a second end;
a cartridge containing ink for the writing instrument positioned axially inside said body member, said cartridge having a first end and a second end, with said first end being a writing end;
a sleeve having a surface axially between said body member and said cartridge, wherein said surface having at least one visual image; and
a magnification means located between said first end and the second end of said body member to magnify said at least one visual image on said surface of said sleeve.
